(19) United States
(12) Patent Application Publication
(10) Pub. No.: US 2015/0307351 A1
(43) Pub. Date: Oct. 29, 2015

(54) TAIL GAS PROCESSING FOR LIQUID HYDROCARBONS SYNTHESIS

(71) Applicants: Rachid Mabrouk, Munich (DE); Joseph Naumovitz, Lebanon, NJ (US)

(72) Inventors: Rachid Mabrouk, Munich (DE); Joseph Naumovitz, Lebanon, NJ (US)

(21) Appl. No.: 14/637,524

(22) Filed: Mar. 4, 2015

Related U.S. Application Data
(60) Provisional application No. 61/982,501, filed on Apr. 22, 2014.

(51) Int. Cl. C01B 3/36; B01J 19/24; C01B 3/34

(52) U.S. Cl. CPC C01B 3/366; C01B 3/34; B01J 19/24; C01B 2203/0216; C01B 2203/0255; C01B 2203/042; C01B 2203/0883; B01J 2219/00103; B01J 2219/24

(57) ABSTRACT

A pressure swing adsorption (PSA) method provides a tail gas stream that is compressed and reformed by at least one of partial oxidation and steam reforming apparatus to produce a synthesis gas with a hydrogen to carbon monoxide ratio. The synthesis gas produced is usable for downstream synthesis of synthetic fuels and/or oxygenates. An apparatus is also provided.

### BACKGROUND

The present embodiments relate to apparatus and methods for using pressure swing adsorption (PSA) tail gas.

To date, it is known to burn or combust PSA tail gas because it is a low grade combustible in a steam methane reformer (SMR) furnace. There is therefore very little use for the tail gas in known processes. Known PSA and steam methane reformer (SMR) furnace systems use the tail gas as a combustible fuel, instead of considering the tail gas for valuable products.

A considerable amount of energy is used to convert natural gas to synthesis gas and therefore, it would be beneficial to maximize conversion of the syngas into valuable products. However, current PSA designs do not completely recover the valuable components hydrogen (H₂) and carbon monoxide (CO) from the syngas that is produced. A significant portion of these components is lost in the tail gas stream that is sent to the combustion system. An example of a tail gas composition from a PSA unit is summarized in the following Table 1:

| Components | Mole Fraction (%) |
|---|---|
| CO | 8.11 |
| H₂ | 27.03 |
| CO₂ | 48.38 |
| H₂O | 1.11 |
| CH₄ | 14.45 |
| N₂ | 0.92 |

In gas to liquid (GTL) applications, the PSA tail gas stream could be considered for use in the downstream Fischer-Tropsch process. However, the tail gas stream composition of Table 1 has a ratio of H₂/CO which is too great for direct utilization. In addition, the methane (CH₄) and carbon dioxide (CO₂) impurities would degrade Fischer-Tropsch reactor performance.

### SUMMARY OF THE INVENTION

The present embodiments employ tailgas processing to further condition the tailgas to be suitable for direct use in for example a Fischer-Tropsch reactor system.

Tail gas processing for liquid hydrocarbon synthesis includes reforming the tail gas stream that is rich in carbon dioxide (CO₂), hydrogen (H₂) and some methane (CH₄), into a carbon monoxide (CO), hydrogen rich stream (a synthesis gas stream) and pure hydrogen stream. The synthesis gas stream that is generated in this system can be used in many downstream applications such as Fischer-Tropsh synthesis, methanol synthesis, and Di-methyl Ether (DME) synthesis, among other downstream applications.

The present embodiments relate to the upgrading of a PSA tail gas stream from an existing hydrogen plant. This is accomplished by compressing the PSA tail gas stream and reforming this stream. Because this stream contains a significant concentration of carbon dioxide (CO₂,) the reforming process is dominated by the reverse water gas shift reaction as shown in the following reaction:

CO₂+H₂ [symbol] CO+H₂O

This reverse water gas shift reaction reduces the hydrogen (H₂) to carbon monoxide (CO) ratio (H₂:CO) in the resulting syngas to between 2 and 2.5. This is a synthesis gas quality that is suitable for downstream synthesis, such as for example methanol and Fischer-Tropsch synthesis.

There is therefore provided a method embodiment of using process off gases or/and tail gas stream of a pressure swing absorption (PSA) apparatus, comprising compressing and reforming said tail gas stream for producing carbon monoxide (CO) and hydrogen (H₂).

There is also provided a method embodiment of using a tail gas stream of a pressure swing absorption (PSA) apparatus, comprising compressing and reforming said tail gas stream for producing CO and H₂; mixing said tail gas stream with a mixture of natural gas and steam for producing a tail gas mixture; heating the tail gas mixture to at least 500° C. but not more than 650° C.; feeding the heated tail gas mixture to a reformer reactor for producing a synthesis gas stream; cooling said synthesis gas stream; Directing a portion of the cooled synthesis gas stream to a membrane separator for producing a hydrogen depleted stream; and mixing the hydrogen depleted stream with a remaining portion of the synthesis gas stream for achieving a select ratio of H₂ to CO in said synthesis gas stream.

There is further provided a method including adjustment of H₂ to CO ratio by PSA tail gas to natural gas processed ratio, or alternatively including adjustment of H₂ to CO ratio by an upstream hydrogen membrane used on compressed PSA tail gas.

There is still further provided an apparatus embodiment for using a tail gas stream of a pressure swing absorption (PSA) apparatus, the apparatus including means for compressing and reforming the tail gas stream for producing CO and H₂; means for mixing the tail gas stream with a mixture of natural gas and steam, the mixing means in fluid communication with the compressing and reforming means; a first heat exchanger in fluid communication with the mixing means for heating the mixture to at least 500° C. but not more than 650° C.; a reformer reactor in fluid communication with the first heat exchanger to produce a synthesis gas stream; a second heat exchanger disposed to receive and cool the synthesis gas stream ; means for separating the cooled synthesis gas stream into a first portion directed to a membrane separator to produce a hydrogen depleted stream, and a second portion; and means for mixing said hydrogen depleted stream with the second portion to achieve a select ratio of H₂ to CO in said second portion of the synthesis gas stream.

The apparatus embodiment can also include a third heat exchanger in fluid communication with the stream provided at an outlet of the mixing means.

### BRIEF DESCRIPTION OF THE DRAWINGS

For a more complete understanding of the present embodiments reference may be made to the detailed description taken in conjunction with the following drawings, of which:

FIG. 1 shows a schematic of an apparatus and process flow diagram for processing a tail gas stream in conjunction with a hydrogen membrane system; and

FIG. 2 shows a schematic of an apparatus and process flow diagram for processing a tail gas stream.

### DETAILED DESCRIPTION OF THE INVENTION

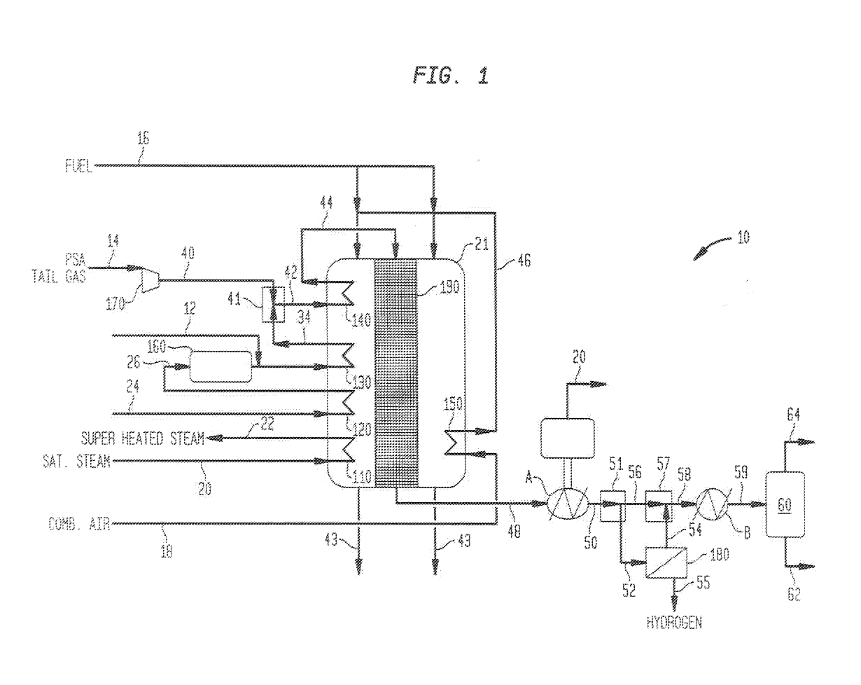

Referring to FIG. 1, a tail gas processing apparatus is shown generally at 10, wherein a natural gas (feed) stream 24 is preheated to a temperature of 350° to 400° in a natural gas heater coil 120 disposed in a waste heat section of a steam methane reformer (SMR) 21. As shown in FIG. 1, a PSA tail gas 14 from a downstream Fischer-Tropsch process (not shown) is introduced into a PSA tailgas compressor 170. A fuel stream 16 (usually including natural gas or naphtha) is introduced into the SMR 21. Accordingly, the present embodiments convert the tail gas stream into a composition that can be used in a downstream Fischer-Tropsch process (which is not shown in FIG. 1). That is, the present embodiments provide for a lower H₂/CO ratio, a methane concentration is reduced by reaction into more CO and H₂, and a concentration of CO₂ is also reduced by reacting it into CO. A heated (natural gas) stream 26 from the coil 120 enters a hydrodesulphurization unit 160 where sulphur compounds are converted to hydrosulfide and carbonyl sulfide which are trapped or adsorbed in a guard bed of the unit 160. The desulphurized stream being admitted to the guard bed of unit 160 is mixed with steam 12 (such as high pressure steam) and then further heated in a natural gas and steam mixture heater coil 130 in the SMR 21. The steam 12 is introduced after unit 160 and upstream of the coil 130.

A heated stream 34 (of mixed steam and natural gas) resulting from the coil 130 is in fluid communication and mixed with a compressed PSA tail gas stream 40 at a “T” section of pipe shown generally at 41. A resulting stream 42 (of the mixture of the tail gas stream 40 and the heated stream 34) is heated in a mixed stream heater coil 140 (or heat exchanger) in the SMR 21 to a temperature of at least 500° C. to not more than 650° C. before being introduced into the reformer tubes reactor 190 which can be conventional pack bed tubes or of a structured monolith type. The reformed gas stream 48 exiting the SMR 21 is then cooled by being introduced into a heat exchanger. Vented flue gas from combustion in the SMR 21 is shown generally at 43.

The reformed gas stream 48 exhausted from the SMR 21 is introduced into a steam boiler A which functions as a heat exchanger to cool the stream. A cool reformed gas stream 50 leaves an outlet of a steam boiler A in a pipe which branches or has a “T” section shown generally at 51. The stream 50 is therefore separated at 51 into a first stream portion 52 and a second stream portion 56. The first stream portion 52 is introduced into a hydrogen membrane separator unit 180 to produce a hydrogen depleted stream 54 and a hydrogen stream 55. The second stream portion 56 is mixed with the hydrogen depleted stream 54 at another pipe “T” section shown generally at 57 and which functions as a mixing means. At the T section 57 the streams 54, 56 are mixed to provide a mixed stream 58 with the reduced H₂:CO ratio, which stream is then introduced into syngas cooler B, which functions as a heat exchanger to cool the stream. An outlet of the syngas cooler B provides a cool mix stream 59 with reduced H₂:CO ratio which is introduced into a gas liquid separator 60. Meanwhile, there is generated a high pressure saturated steam stream 20 which is superheated in a coil 110 (a steam superheater). The produced processed gas (synthesis gas) has been cooled below a dew point of stream 59 (i.e., a cooled mixed stream with a reduced H₂:CO ratio) before entering the gas liquid separator 60 where a condensate stream 62 is separated from a dry gas stream 64 (to a Fischer-Tropsch plant, not shown). The dry gas stream 64 includes hydrogen, carbon monoxide, carbon dioxide and methane.

The hydrogen to carbon monoxide ratio (H₂:CO) can be varied, such as for example between 1.8 and 2.5, depending upon a ratio PSA tail gas to natural gas feed processed upstream. The ability to vary the hydrogen to carbon monoxide ratio is necessary to insure flexibility of the operation, especially during start up of the system.

The ratio of hydrogen to carbon monoxide of the dry gas stream 64 can be controlled and adjusted by other means, such as installing a hydrogen membrane unit 180 for a (cooled reformed) stream 50 where hydrogen is separated from a stream 52 to be a first portion of the cooled reformed gas stream 50. A hydrogen-lean reformed stream 54 leaves the hydrogen membrane unit 180 to be mixed with a stream 56. The stream 56 is a second portion of the cooled reformed gas stream 50. A fraction of the stream 56 is adjusted to obtain a desired ratio of hydrogen to carbon monoxide.

Air 18, which is used for combustion, is introduced into an air heater 150 disposed at an interior of the SMR 21, in one embodiment near a bottom portion of the SMR. Saturated steam 20 is introduced into the steam superheater 110 disposed at an interior of the SMR 21 to produce superheated stream 22, in one embodiment at a lower portion of the SMR. A heated stream 44 which is a mixture of a steam, natural gas and PSA tail gas is removed from the mixed stream heater 140 and sent to the reformer tubes 190. An outlet of the air heater 150 provides heated combustion air 46 to be mixed with the fuel stream 16 for introduction into the combustion side of the SMR 21. A mixed stream 58 has a reduced H₂:CO ratio and results from the mixture of the second portion 56 of the cooled reformed gas stream and the hydrogen lean reformed gas stream 54, for being introduced into a condenser/heat exchanger.

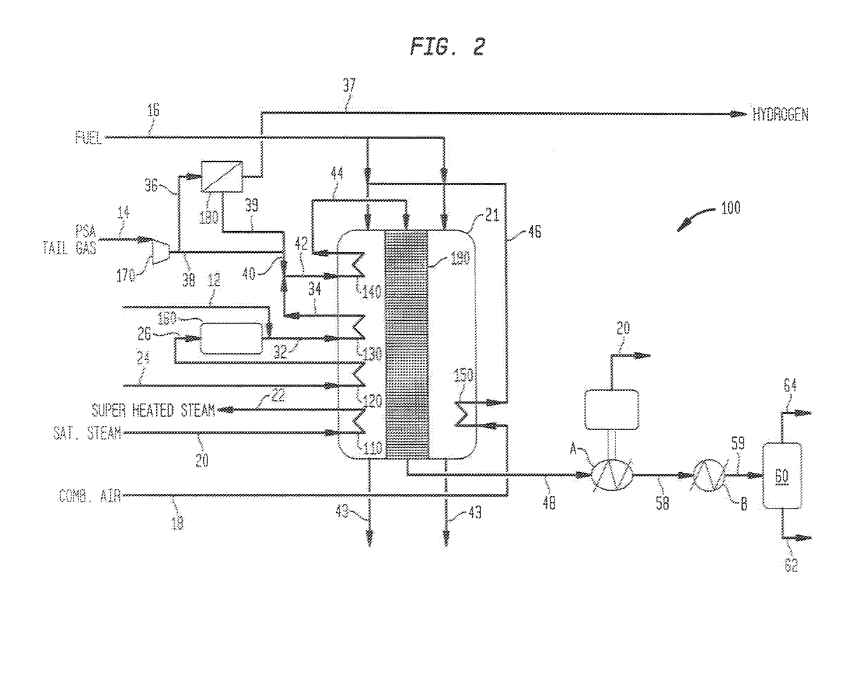

Referring to FIG. 2, such a process layout is similar to the embodiment of FIG. 1, but in a second embodiment 100, the hydrogen to carbon monoxide ratio (H₂:CO) of the dry gas stream 64 is adjusted to desired values while producing a hydrogen rich gas stream 37 (or a hydrogen product stream). Thus, a fraction of the hydrogen contained in a first portion 36 of the compressed PSA tail gas stream is separated in the membrane unit 180. A hydrogen lean gas stream 39 from the unit 180 is returned to and is mixed with the second portion 38 of the PSA tail gas bypass stream to provide a resulting mixed stream 40 of compressed PSA tail gas and the hydrogen lean stream 39, which is mixed with the heated stream 34 from the coil 130. A resulting heated stream 42 is a mixed stream of steam, natural gas, PSA tail gas, and hydrogen lean stream, which is introduced into the coil 140.

Referring still to FIG. 2, a mixed steam and natural gas stream 32 is provided to the natural gas and steam mixture heater 130. An outlet of the mixed stream heater 140 provides a heated mixed stream 44 of steam, natural gas, PSA tailgas, and hydrogen lean stream which is introduced into the tubes 190 of the SMR 21. A coded reformed gas stream 58 is introduced into a condenser/heat exchanger, to provide a further cooled reformed gas stream 59 which is introduced into the gas liquid separator 60.

The present embodiments use a PSA tail gas for producing valuable products, rather than burning the tail gas as a low grade combustible in an SMR furnace. The PSA tail gas upgrade includes compressing and reforming the resulting gas stream by either partial oxidation or by steam reforming processes to get a synthesis gas with hydrogen to carbon monoxide ratio of 2.5 and in certain instances 2. The synthesis gas obtained is suitable for downstream synthesis of fuels and oxygenates.

There is therefore provided herein by the present embodiments of FIGS. 1 and 2,
reforming of an existing pressure swing adsorption tail gas stream, and therefore the methane is reformed mostly into carbon monoxide (CO) and hydrogen (H₂);
producing a low hydrogen to carbon monoxide ratio between 1.8 to 2.5, which is suitable for synthetic fuel and methanol synthesis;
providing hydrogen to carbon monoxide ratio adjustment by the PSA tail gas to natural gas ratio processed feed;
providing a hydrogen to carbon monoxide ratio adjustment by an upstream hydrogen membrane used on the compressed PSA tail gas;
providing a hydrogen to carbon monoxide ratio adjustment by adding a downstream hydrogen membrane used either on wet or dry reformed gas;
providing the pressure swing adsorption tail gas from an existing hydrogen plant, which tail gas is compressed to a pressure between 15 to 30 bars (an ionic wet gas compressor, or gas/steam ejector could be used); and
reforming hydrocarbon tail gas, from downstream synthesis (methanol synthesis and fuel synthesis) together with the stream from the reforming as discussed above.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed:

1. A method of using a tail gas stream of a pressure swing absorption (PSA) apparatus, comprising:
compressing and reforming said tail gas stream for producing carbon monoxide (CO) and hydrogen (H₂).

2. The method of claim 1, wherein a ratio of the H₂ to the CO is from 2 to 2.5.

3. The method of claim 1, comprising adjusting the H₂ to CO ratio by a ratio of the PSA tail gas to natural gas processed.

4. The method of claim 1, comprising adjusting the H₂ to CO ratio by an upstream hydrogen membrane used on compressed PSA tail gas.

5. The method of claim 1, comprising adjusting the H₂ to CO ratio by using a downstream hydrogen membrane on a gas selected from the group consisting of a wet reformed gas, and a dry reformed gas.

6. The method of claim 1, wherein the compressing is at a pressure of between 15 bara to 30 bara.

7. The method of claim 1, further comprising reforming hydrocarbon tail gas from a downstream synthesis of methanol synthesis and fuel synthesis together with a stream produced from the compressing and reforming the tail gas stream for producing CO and H₂.

8. The method of claim 1, wherein the compressing and reforming comprises processing of said tail gas stream by partial oxidation.

9. The method of claim 1 wherein the compressing and reforming comprises processing said tail gas stream with steam reforming equipment.

10. A method of using a tail gas stream of a pressure swing absorption (PSA) apparatus, comprising:
compressing and reforming said tail gas stream for producing CO and H₂;
mixing said tail gas stream with a mixture of natural gas and steam for producing a tail gas mixture;
heating the tail gas mixture to at least 500° C. but not more than 650° C.;
feeding the heated tail gas mixture to a reformer reactor for producing a synthesis gas stream;
cooling said synthesis gas stream;
directing a portion of the cooled synthesis gas stream to a membrane separator for producing a hydrogen depleted stream; and
mixing the hydrogen depleted stream with a remaining portion of the synthesis gas stream for achieving a select ratio of H₂ to CO in said synthesis gas stream.

11. The method of claim 10, wherein a ratio of the H₂ to the CO is from 2 to 2.5.

12. The method of claim 10, comprising adjusting the H₂ to CO ratio is by a ratio of the PSA tail gas to natural gas processed.

13. The method of claim 10, comprising adjusting the H₂ to CO ratio by an upstream hydrogen membrane used on compressed PSA tail gas.

14. The method of claim 10, comprising adjusting the H₂ to CO ratio by using a downstream hydrogen membrane on a gas selected from the group consisting of a wet reformed gas and a dry reformed gas.

15. The method of claim 10, wherein the compressing is at a pressure of between 15 bara to 30 bara.

16. The method of claim 10, further comprising reforming hydrocarbon tail gas from a downstream synthesis of methanol synthesis and fuel synthesis together with a stream produced from the compressing and reforming the tail gas stream for producing CO and H₂.

17. The method of claim 10, wherein the compressing and reforming comprises processing of said tail gas stream by partial oxidation.

18. The method of claim 10 wherein the compressing and reforming comprises processing said tail gas stream with steam reforming equipment.

19. An apparatus for using a tail gas stream of a pressure swing absorption (PSA) apparatus, comprising:
means for compressing and reforming (170) the PSA tail gas stream (14) for producing CO and H₂;
means for mixing (41) a tail gas stream (40) with a mixture of natural gas and steam (34), the mixing means in fluid communication with the compressing and reforming means (170);
a first heat exchanger (140) in fluid communication with the mixing means (41) for heating the mixture to at least 500° C. but not more than 650° C.;
a reformer reactor (190) in fluid communication with the first heat exchanger (140) to produce a synthesis gas stream (48);
a second heat exchanger (A) disposed to receive and cool the synthesis gas stream (48);
means for separating (51) the cooled synthesis gas stream into a first portion (52) directed to a membrane separator (180) to produce a hydrogen depleted stream (54), and a second portion (56); and
means for mixing (57) said hydrogen depleted stream (54) with the second portion (56) to achieve a select ratio of H₂:CO in said second portion (56) of the synthesis gas stream to provide a mixed stream (58) with a reduced H₂:CO ratio.

20. The apparatus of claim 19, further comprising a third heat exchanger (B) in fluid communication with the stream 58 provided at an outlet of the mixing means 57.
